(19) United States
(12) Patent Application Publication
(10) Pub. No.: US 2005/0177768 A1
(43) Pub. Date: Aug. 11, 2005

(54) Update detection device and update detection program

(75) Inventor: Yasuji Imamura, Okazaki-city (JP)

Correspondence Address: POSZ LAW GROUP, PLC, 12040 SOUTH LAKES DRIVE, SUITE 101, RESTON, VA, 20191, US

(73) Assignees: DENSO CORPORATION; TOYOTA JIDOSHA KABUSHIKI KAISHA

(21) Appl. No.: 11/038,264

(22) Filed: Jan. 21, 2005

(30) Foreign Application Priority Data
Jan. 26, 2004 (JP) 2004-16914

(51) Int. Cl. G06F 11/00

(52) U.S. Cl. 714/13

(57) ABSTRACT

During power-on of a navigation device, a control circuit executes an investigation process for determining whether backup data stored in a memory should be erased. In this investigation process, the control circuit confirms that a first determination or a second determination is affirmed, based on a large volume storage medium being presently attached. The first determination is whether the attached medium is substituted during power-off of the navigation device, while the second is whether information stored in the attached medium is updated during the power-off. Affirming of the first determination or the second determination is judged from whether a use restriction is applied to the attached medium, whether a serial number of the attached medium accords with a serial number stored in the navigation device, and whether a password stored in the navigation device can access to the attached medium.

### CROSS REFERENCE TO RELATED APPLICATIONS

This application is based on and incorporates herein by reference Japanese Patent Application No. 2004-16914 filed on Jan. 26, 2004.

### FIELD OF THE INVENTION

The present invention relates to a device and a program of update detection that processes backup data based on updating of information stored in a storage medium.

### BACKGROUND OF THE INVENTION

A conventional navigation device reads out map information or the like from a large volume storage medium such as a CD-ROM, a DVD-ROM, or an HDD (Hard Disk Drive), to use them for various functions. This large volume storage medium includes, within the contained large volume data, map information for periphery of a present position or the like that is frequently used. A computation result is obtained based on the information stored in the large volume storage medium. The frequently used information and the computation result are temporarily stored as backup data in a non-volatile memory such as a DRAM powered by a battery in a vehicle, so as to achieve high speed processing. Outstanding Information including the present position information and the memory spot information thereby continue to be stored in the DRAM, even after the navigation device is turned off. Therefore, when the navigation device is re-powered, high speed processing becomes possible (refer to Patent Document 1).
Patent Document 1: JP-H5-323869 A

Further, when information stored in the large volume storage medium is updated, backup data referring to the information prior to the update possibly outputs erroneous information. Therefore, the information stored in the non-volatile memory such as a DRAM must be erased. For this purpose, conventionally, information stored in a non-volatile memory is physically erased by a structure where a large volume storage medium can be removed only when a power from a vehicle battery is turned off. Otherwise, ejection operation of a large volume storage medium such as a CD-ROM, a DVD-ROM, or a HDD is allowed only while the power of the navigation device is being turned on. This ejection operation can be thereby detected by a software program, so that information stored in the non-volatile memory is erased.

However, the above structure where a large volume storage medium can be removed only when a power from a vehicle battery is turned off, involves necessity of bothersome works or possible erasing or resetting of setting information. The bothersome works are such that removing of the navigation device itself or the power source from the vehicle each time the information is updated periodically. The setting information is stored in the non-volatile memory and other than the backup data relating to the information stored in the large volume storage medium. Further, the method where the ejection operation of a large volume storage medium is allowed only while the power of the navigation device is being turned on, poses another problem. That is, when the large volume storage medium is removed while the power is turned off and then updated, this updating cannot be detected. Furthermore, when a hardware detects removing of the large volume storage medium while the power is turned off, an additional component is required, resulting in increase in the cost.

### SUMMARY OF THE INVENTION

It is an object of the present invention to provide a device or program for update detection that is capable of properly erasing backup data stored in a non-volatile memory, even when the large volume storage medium is removed while the power of the device is turned off.

To achieve the above object, an update detection device is provided with the following. At least two information storing units are included and attachable to an information reading device. A backup storing unit is included for storing backup information relating to information stored in an information storing unit that is attached to the information reading device. At least one of a first determination and a second determination is performed. Here, the first determination is whether or not information stored in a given information storing unit that is attached to the information reading device is updated after the given information storing unit was removed, during power-off of the information reading device, from the information reading device. The second determination is whether or not the given information storing unit is substituted during power-off of the information reading device. Here, the backup information stored in the backup storing unit is erased when at least one of the first determination and the second determination is affirmed.

In another aspect of the present invention, an update detection device is provided with the following. At least one information storing unit is included for being attached to an information reading device and for storing information that is able to be read. A backup storing unit is included for storing backup information relating to the information stored in the information storing unit. At start-up of the information reading device, it is determined whether or not the information stored in the information storing unit that is attached to the information reading device is updated during power-off of the information reading device. Here, the backup information stored in the backup storing unit is erased when the information stored in the information storing unit that is attached to the information reading device is determined to be updated.

In each structures of the above two aspects of the invention, an update determining unit performs determination at start-up of an information reading device. In this determination, substitution of the information storing unit (or large volume storage medium) or information update in the information storing unit, during power-off of the information reading device, is determined irrespective of detaching from the information reading device. Backup information that may refers to information prior to the substitution or the update is thereby erased, so that prevention for mis-operation, or erasing of unnecessary information can become possible. Thus, works at substituting the information storing unit or updating the information can become easy. Here, the update detection device can be assembled into the information reading device, or can be disposed separately from the information reading device.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram of a structure of a navigation device according to an embodiment of the present invention; and

FIG. 2 is a flow chart diagram showing an investigation process according to the embodiment.

### DETAILED DESCRIPTION OF THE PREFERRED EMBODIMENTS

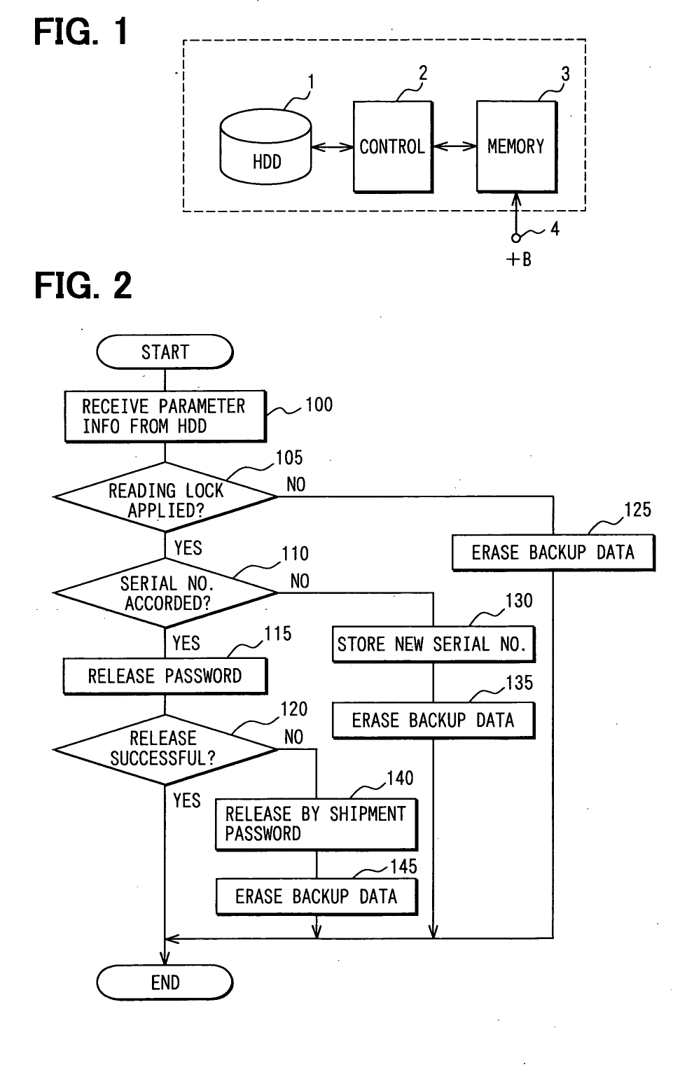

An embodiment of the present invention will be explained with reference to FIGS. 1, 2. FIG. 1 shows a structure of a navigation device according to the embodiment. The navigation device functioning as an information reading device includes a large volume storage medium 1, a control circuit 2, a memory 3, a known position detector (not shown), and a display device (not shown). The large volume storage medium 1 is constructed of a CD-ROM, a DVD-ROM, an HDD, or the like, which stores map information necessary for navigation. Here, this embodiment uses the HDD as the large volume storage medium 1 or information storing unit, so that the HDD and the large volume storage medium 1 are almost equivalently used. The HDD has a lock (or HDD-reading lock) that a use restriction on reading out information is applied to the HDD using a password, so that the information stored in the HDD cannot be read out when the HDD is attached to another device. This lock is applied to the HDD when use of the HDD is normally terminated, i.e., when the navigation device ends its operation or when information update to the HDD is completed at a service shop such as a dealer.

The control circuit 2 is constructed of a computer including a known CPU, a ROM a RAM, an Input and output, and a bus line interfacing with the foregoing components. The ROM in the control circuit 2 stores a program that executes updating information stored in a large volume storage medium or a process for investigation of substitution of the large volume storage medium. Further, the ROM in the control circuit 2 stores a password used for releasing an HDD-reading lock and for thereby reading information stored in the HDD.

The memory 3 is constructed of a non-volatile memory such as a DRAM and powered by a power terminal 4 (B+ in FIG. 1) connected with a vehicle battery. The memory 3 stores as backup data: frequently used information, within the large volume information stored in the large volume storage medium 1, such as map information for periphery of a present position; and computation results or the like obtained based on the information stored in the large volume storage medium 1, with each of the both information associated with a serial number uniquely assigned to the HDD.

In the above structure, at start-up of the navigation device, the control circuit 2 executes an investigation process for determining whether backup data stored in a memory 3 should be erased, based on a result of the following determinations. In this investigation process, the control circuit 2 determines at start-up of the navigation device (when the navigation device is started), based on the presently attached large volume storage medium 1, whether or not the large volume storage medium 1 is substituted during power-off of the navigation device, or whether or not information stored in the large volume storage medium 1 is updated during the power-off. Here, substituting the large volume storage medium 1 is assumed to mean that the information within the large volume storage medium 1 is updated.

The investigation process executed by the control circuit 2 will be explained with reference to FIG. 2. This process is started when the power of the navigation device is turned on (or at start-up of the navigation device).

At Step 100, parameter information is received from the large volume storage medium 1. The parameter information that the circuit 2 can obtain from the HDD includes a serial number uniquely assigned to the HDD, and a state of an HDD-reading lock.

At Step 105, it is determined whether an HDD-reading lock is applied to the large volume storage medium 1 based on the received parameter information. When the lock is determined to be applied not to the large volume storage medium 1 (Step 105: NO), it is supposed that the lock is not applied though information stored in the large volume storage medium 1 is updated, or that the large volume storage medium 1 is substituted. Therefore, the backup data stored in the memory 3 is erased at Step 125, which then terminates the process. That is, when the lock (or use restriction) that should be usually applied after a normal end of using the HDD is not applied, it is supposed that any information manipulation is performed on the HDD. Thus, securely erasing the backup data can be achieved by determining whether or not the lock is applied to the large volume storage medium 1 being presently attached.

By contrast, when the lock is determined to be applied at Step 105 (Step 105: YES), the process advances to Step 110. Here, it is determined whether a serial number of the large volume storage medium 1 being presently attached accords with a serial number of the large volume storage medium 1 that was previously attached at power-off (at the timing when the power is turned off or when the device is terminated). Here, the serial number of the large volume storage medium 1 that was attached at power-off is stored in the memory 3 while being associated with the backup data.

When the serial numbers are determined not to be accorded with each other (Step 110: NO), it is determined that the large volume storage medium 1 being presently attached is different from that being attached when the device is terminated. The process thereby advances to Step 130, where the serial number of the large volume storage medium 1 being presently attached is newly stored in the memory 3.

At Step 135, the backup data stored in the memory 3 is then erased, which thereby terminates the process. That is, the serial number of the large volume storage medium 1 that was attached prior to power-off is compared with the serial number of the large volume storage medium 1 that is presently attached, at start-up (or at the timing when the power is turned on again). Whether or not the large volume storage medium 1 is substituted can be thereby detected. Thus, comparing the serial numbers enables securely detecting of the substitution of the large volume storage medium 1, thereby resulting in properly erasing of the backup data.

By contrast, when the serial numbers are determined to be accorded with each other (Step 110: YES), the process advances to Step 115. Here, a release process is performed using a usual password of the HDD stored in the ROM in the control circuit 2. In the releasing process, the HDD-reading lock applied to the HDD is to be released. Here, the ROM in the control circuit 2 includes the usual password (individual password) and a password for shipment (common password, master password). The usual password is an individual password corresponding to each navigation device, so that the navigation device applies or releases an HDD-reading lock using the usual password. On the other hand, when a service shop such as a dealer updates the HDD, the password for shipment (master password) is used for applying or releasing an HDD-reading lock.

At Step 120, it is determined whether the release process at Step 115 is successfully completer or not. When the release process is determined to be successfully completed (Step 120: YES), it is supposed that the usual password is effective. Therefore, the lock has been applied since the navigation device was terminated, so that the information within the large volume storage medium 1 is determined to be not updated. This terminates the process.

By contrast, when the release process is determined to be not successfully completed (Step 120: NO), it is supposed that the usual password is not effective. It is thereby determined that there is high possibility that the information within the large volume storage medium 1 is updated, so that at Step 140 a release process where the lock applied to the large volume storage medium 1 is to be released is performed using the password for shipment stored in the ROM in the control circuit 2. After releasing the lock to the large volume storage medium 1, the backup data stored in the memory 3 is erased at Step 145.

That is, on the assumption that the usual password is used for applying the lock to the large volume storage medium 1, when the same usual password stored in the ROM is not effective at the subsequent start-up in the large volume storage medium 1 that is being attached, the following two cases are assumed to occur. The first is that the information within the large volume storage medium 1 is updated and then the lock is applied using another password, while the second is that the large volume storage medium 1 that is previously attached is replaced by another one that is presently attached. Therefore, by determining whether the release of the lock using the usual is successfully completed or not, the backup information can be properly erased.

After the investigation process in FIG. 2 is terminated, the navigation device starts a conventional function such as destination retrieving or route guiding. Thereafter, when the navigation device is stopped (when the power of the navigation device is turned off), an HDD-reading lock is applied to the large volume storage medium 1 using the usual password stored in the ROM in the control circuit 2. Thus, when the information in the large volume storage medium 1 is not updated, the lock is being applied to the large volume storage medium 1 at the timing when the power is again turned on. As a result, in again performing the investigation process shown in FIG. 2, the lock is determined to be applied (Step 105: YES), the serial numbers are determined to be accorded with each other since the HDD is not replaced (Step 110: YES), and the lock can be released by using the usual password (Step 120: YES). No backup data is thereby erased. Consequently, even after the power of the navigation device is turned off, information that is being used such as the present position information or memory spot information is stored in the DRAM, so that a quick process can be performed at the timing when the power is again turned on.

As explained above, the navigation device of the embodiment executes, at the timing when the navigation device is started, confirmation of the function lock to the HDD, comparison of the serial numbers, and release of the lock using the usual password. By this process, the navigation device can detect the replacement of the HDD or information update in the HDD during the power-off, to thereby able to properly erase the backup data stored in the non-volatile memory. This enables a smooth update for information stored in the large volume storage medium.

In this embodiment, the update detection device of the present invention is assembled in the navigation device; however, a control circuit 2 and a memory 3 can be additionally disposed separately from those of the navigation device.

Further, in the above embodiment, information update for the large volume storage medium 1 is executed in the service shop such as a dealer while the large volume storage medium 1 is removed during the power-off of the navigation device. However, during the power-off of the navigation device, the information can be updated by directly connecting a power supplying line and a signal line with the large volume storage medium 1. In this case, the lock cannot be applied to the large volume storage medium 1 using the password stored in the ROM in the control circuit 2. Therefore, by the investigation process shown in FIG. 2, the information update within the large volume storage medium 1 can be detected, so that the backup data within the memory 3 can be erased.

It will be obvious to those skilled in the art that various changes may be made in the above-described embodiments of the present invention. However, the scope of the present invention should be determined by the following claims.

1. An update detection device comprising:
at least two information storing units that are attachable to an information reading device;
a backup storing unit that stores backup information relating to information stored in an information storing unit that is attached to the information reading device;
an update determining unit that performs at least one of
a first determination of whether or not information stored in a given information storing unit that is attached to the information reading device is updated after the given information storing unit was removed, during power-off of the information reading device, from the information reading device, and
a second determination of whether or not the given information storing unit is substituted during power-off of the information reading device; and
a control unit that erases the backup information stored in the backup storing unit when at least one of the first determination and the second determination is affirmed.

2. The update detection device of claim 1, further comprising:
a lock determining unit that determines at start-up of the information reading device whether a use restriction is applied to the given information storing unit that is attached to the information reading device,
wherein, when a use restriction is determined not to be applied to the given information storing unit, the update determining unit determines that at least one of the first determination and the second determination is affirmed.

3. The update detection device of claim 1, further comprising:
a serial number storing unit that stores a serial number included in an information storing unit; and
a comparing unit that compares at start-up of the information reading device a serial number included in the given information storing unit and a serial number previously stored in the serial number storing unit,
wherein, when the comparing unit determines that the serial number included in the given information storing unit and the serial number stored in the serial number storing unit are different from each other, the update determining unit determines that at least one of the first determination and the second determination is affirmed.

4. The update detection device of claim 1, further comprising:
a password storing unit that stores a password for applying a use restriction to an information storing unit; and
a release unit that releases at start-up of the information reading device a use restriction to an information storing unit using a password stored in the password storing unit,
wherein, when the release unit fails in releasing the use restriction to the given information storing unit, the update determining unit determines that at least one of the first determination and the second determination is affirmed.

5. An update detection device comprising:
at least one information storing unit that is attached to an information reading device and that stores information that is able to be read;
a backup storing unit that stores backup information relating to the information stored in the information storing unit;
an update determining unit that determines at start-up of the information reading device whether or not the information stored in the information storing unit that is attached to the information reading device is updated during power-off of the information reading device; and
a control unit that erases the backup information stored in the backup storing unit when the information stored in the information storing unit that is attached to the information reading device is determined to be updated.

6. The update detection device of claim 5, further comprising:
a lock determining unit that determines at start-up of the information reading device whether a use restriction is applied to the information storing unit,
wherein, when a use restriction is determined not to be applied to the information storing unit that is attached to the information reading device, the update determining unit determines that the information stored in the information storing unit that is attached to the information reading device is updated during power-off of the information reading device.

7. The update detection device of claim 5, further comprising:
a serial number storing unit that stores a serial number included in an information storing unit; and
a comparing unit that compares at start-up of the information reading device a serial number included in the information storing unit that is attached to the information reading device and a serial number previously stored in the serial number storing unit,
wherein, when the comparing unit determines that the serial number included in the information storing unit that is attached to the information reading device and the serial number stored in the serial number storing unit are different from each other, the update determining unit determines that the information stored in the information storing unit that is attached to the information reading device is updated during power-off of the information reading device.

8. The update detection device of claim 5, further comprising:
a password storing unit that stores a password for applying a use restriction to an information storing unit; and
a release unit that releases at start-up of the information reading device a use restriction to an information storing unit using a password stored in the password storing unit,
wherein, when the release unit fails in releasing the use restriction to the information storing unit that is attached to the information reading device, the update determining unit determines that the information stored in the information storing unit that is attached to the information reading device is updated during power-off of the information reading device.

9. A computer program product in a computer readable medium for use in update detection performed by using at least two information storing units that are attachable to an information reading device and a backup storing unit that stores backup information relating to information stored in an information storing unit that is attached to the information reading device; the computer program product comprising:
instructions for performing at least one of
a first determination of whether or not information stored in a given information storing unit that is attached to the information reading device is updated after the given information storing unit was removed, during power-off of the information reading device, from the information reading device, and
a second determination of whether or not the given information storing unit is substituted during power-off of the information reading device; and
instructions for erasing the backup information stored in the backup storing unit when at least one of the first determination and the second determination is affirmed.

10. The computer program product of claim 9, further comprising:
instructions for determining at start-up of the information reading device whether a use restriction is applied to the given information storing unit,
wherein, when a use restriction is determined not to be applied to the given information storing unit, at least one of the first determination and the second determination is affirmed.

11. The computer program product of claim 9, further comprising:
instructions for previously storing a certain serial number included in an information storing unit; and
instructions for comparing at start-up of the information reading device a serial number included in the given information storing unit and the stored certain serial number,
wherein, when the serial number stored in the given information storing unit is determined to be different from the stored certain serial number, at least one of the first determination and the second determination is affirmed.

12. The computer program product of claim 9, further comprising:
instructions for storing a password for applying a use restriction to an information storing unit; and
instructions for releasing at start-up of the information reading device a use restriction to the given information storing unit using the stored password,
wherein, when releasing the use restriction to the given information storing unit fails, at least one of the first determination and the second determination is affirmed.

13. A computer program product in a computer readable medium for use in update detection performed by using at least one information storing unit that is attached to an information reading device and a backup storing unit that stores backup information relating to information stored in the information storing unit; the computer program product comprising:
instructions for determining at start-up of the information reading device whether or not the information stored in the information storing unit that is attached to the information reading device is updated during power-off of the information reading device; and
instructions for erasing the backup information stored in the backup storing unit when the information stored in the information storing unit that is attached to the information reading device is determined to be updated.

14. The computer program product of claim 13, further comprising:
instructions for determining at start-up of the information reading device whether a use restriction is applied to the information storing unit,
wherein, when a use restriction is determined not to be applied to the information storing unit that is attached to the information reading device, the information stored in the information storing unit that is attached to the information reading device is determined to be updated during power-off of the information reading device.

15. The computer program product of claim 13, further comprising:
instructions for previously storing a certain serial number included in an information storing unit; and
instructions for comparing at start-up of the information reading device a serial number included in the information storing unit that is attached to the information reading device and the stored certain serial number,
wherein, when the serial number included in the information storing unit that is attached to the information reading device is determined to be different from the stored certain serial number, the information stored in the information storing unit that is attached to the information reading device is determined to be updated during power-off of the information reading device.

16. The computer program product of claim 13, further comprising:
instructions for storing a password for applying a use restriction to an information storing unit; and
instructions for releasing at start-up of the information reading device a use restriction to the information storing unit that is attached to the information reading device using the stored password,
wherein, when releasing the use restriction to the information storing unit that is attached to the information reading device fails, the information stored in the information storing unit that is attached to the information reading device is determined to be updated during power-off of the information reading device.

17. A method for use in update detection performed by using at least two information storing units that are attachable to an information reading device and a backup storing unit that stores backup information relating to information stored in an information storing unit that is attached to the information reading device; the method comprising steps of:
performing at least one of
a first determination of whether or not information stored in a given information storing unit that is attached to the information reading device is updated after the given information storing unit was removed, during power-off of the information reading device, from the information reading device, and
a second determination of whether or not the given information storing unit is substituted during power-off of the information reading device; and
erasing the backup information stored in the backup storing unit when at least one of the first determination and the second determination is affirmed.

18. A method for use in update detection performed by using at least one information storing unit that is attached to an information reading device and a backup storing unit that stores backup information relating to information stored in the information storing unit; the computer program product comprising:
determining at start-up of the information reading device whether or not the information stored in the information storing unit that is attached to the information reading device is updated during power-off of the information reading device; and
erasing the backup information stored in the backup storing unit when the information stored in the information storing unit that is attached to the information reading device is determined to be updated.
